(19) United States
(12) Patent Application Publication
(10) Pub. No.: US 2026/0016065 A1
(43) Pub. Date: Jan. 15, 2026

(54) ISOLATOR

(71) Applicant: The Pullman Company LLC, Northville, MI (US)

(72) Inventor: Zoren E. GASPAR, Huron, OH (US)

(21) Appl. No.: 18/769,594

(22) Filed: Jul. 11, 2024

(51) Int. Cl. F16F 1/376

(52) U.S. Cl. CPC F16F 1/376; F16F 2230/0005; F16F 2230/02

(57) ABSTRACT

An isolator comprises an inner core including a bore extending therethrough, an outer shell including a cylindrical wall and an elastomer positioned radially between the inner core and the outer shell. The elastomer includes a first leg and a diametrically opposed second leg as well as a third leg in a diametrically opposed fourth leg. The first leg and the second leg interconnect the inner core and the outer shell and originate at the inner core and diverge radially outwardly along a first longitudinal direction. The third leg and the fourth leg each interconnect the inner core and the outer shell and originate at the

### FIELD

The present disclosure relates to an isolator for mounting components of a vehicle to one another. More particularly, the present disclosure relates to an isolator configured to exhibit a radial rate having substantially the same magnitude as an axial rate to allow the isolator to be mounted in a variety of different orientations.

### BACKGROUND

Statements in this section merely provide background information related to the present disclosure and may not constitute prior art.

Automotive vehicles are typically equipped with several different types of components mounted to a frame or a central structure. These components may include an internal combustion engine, a transmission, an electric drive motor, gearboxes or differentials, pumps, suspension components, exhaust system components, and the like. It is often desirable to mount the component to the vehicle in a manner to prevent or at least minimize vibrations from being transmitted from one component to another or to the frame or central structure. Isolators or elastomeric mounts have been provided in the past to perform these functions.

At least one known isolator includes an elastomer shaped as a puck with at least one aperture extending therethrough. The aperture is in receipt of an elongated metal stud hanger. The metal stud hanger may be provided with an enlarged tapered head at one end that may be forced through the aperture in the isolator. The opposite end of the metal stud hanger may be fixed to the component to be mounted.

Other isolators include elastomeric bodies with a shear hub design. The elastomer is shaped as a contiguous circumferentially extending cylindrical body mounted in an outer housing. The outer housing is fixed to the vehicle and the aperture is in receipt of a metal stud hanger.

While these designs have functioned satisfactorily in the past, such configurations often exhibit a soft rate when loaded in the radial direction. A significantly higher rate is provided when the isolator is mounted in the axial direction. To properly utilize the shear hub designs of the prior art, a particular orientation of the isolator should be maintained. To accommodate new opportunities for mounting and simultaneously minimizing the transfer of noise, vibration and harshness, it may be beneficial to further develop new isolator designs.

### SUMMARY

An isolator comprises an inner core including a bore extending therethrough, an outer shell including a cylindrical wall and an elastomer positioned radially between the inner core and the outer shell. The elastomer includes a first leg and a diametrically opposed second leg as well as a third leg in a diametrically opposed fourth leg. The first leg and the second leg interconnect the inner core and the outer shell and originate at the inner core and diverge radially outwardly along a first longitudinal direction. The third leg and the fourth leg each interconnect the inner core and the outer shell and originate at the inner core and diverge inwardly outwardly along a second longitudinal direction opposite to the first opposite to the first longitudinal direction.

In an alternate arrangement an isolator includes an elastomer positioned radially between an inner core and an outer shell. The elastomer includes a first leg and a diametrically opposed second leg as well as a third leg and a diametrically opposed fourth leg. The first leg and the second leg define a first pair of legs arranged to define a conically-section that opens in a longitudinal direction. The third leg and the fourth leg define a second pair of legs arranged to define a conical cross-section that opens in a second longitudinal direction.

### BRIEF DESCRIPTION OF THE DRAWINGS

The present disclosure will become more fully understood from the detailed description and the accompanying drawings, wherein:

FIG. 1 is perspective view of an exemplary isolator constructed in accordance with the teachings of the present disclosure;

FIG. 2 is another perspective view of the isolator depicted in FIG. 1;

FIG. 3 is an exploded view of the isolator depicted in FIG. 1;

FIG. 4 is an end view of the isolator depicted in FIG. 1;

FIG. 5 is a cross-sectional view taken along line 5-5 as shown in FIG. 4;

FIG. 6 is a cross-sectional view taken along line 6-6 as shown in FIG. 4;

FIG. 7 is a cross-sectional view of an alternate embodiment isolator constructed in accordance with the teachings of the present disclosure; and

FIG. 8 is another cross-sectional view of the alternate embodiment isolator.

In the drawings, reference numbers may be reused to identify similar and/or identical elements.

### DETAILED DESCRIPTION

Example embodiments will now be described more fully with reference to the accompanying drawings.

Example embodiments are provided so that this disclosure will be thorough, and fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

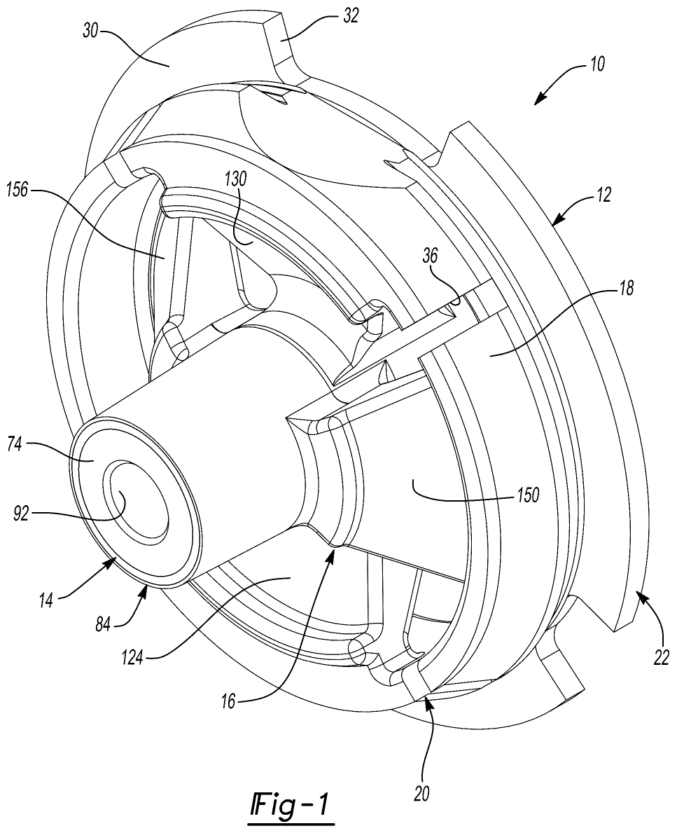

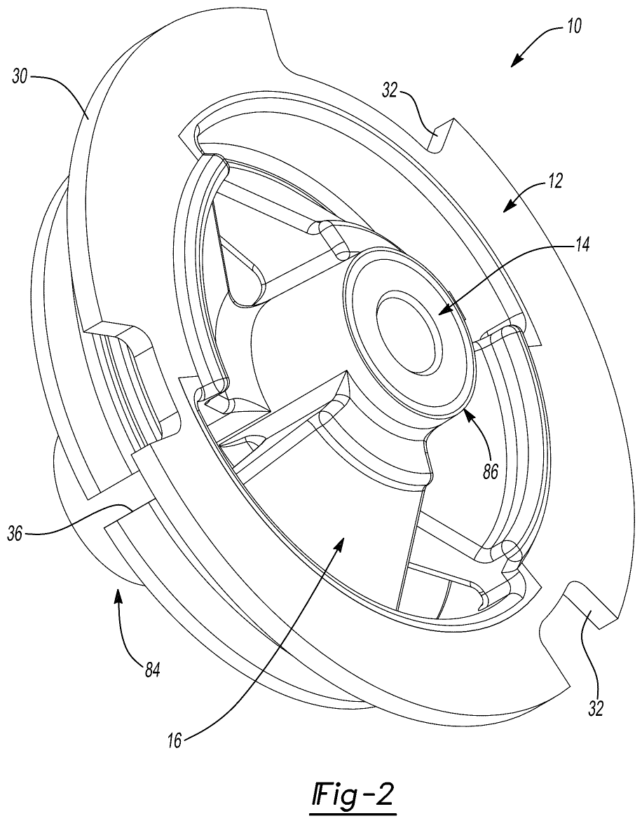

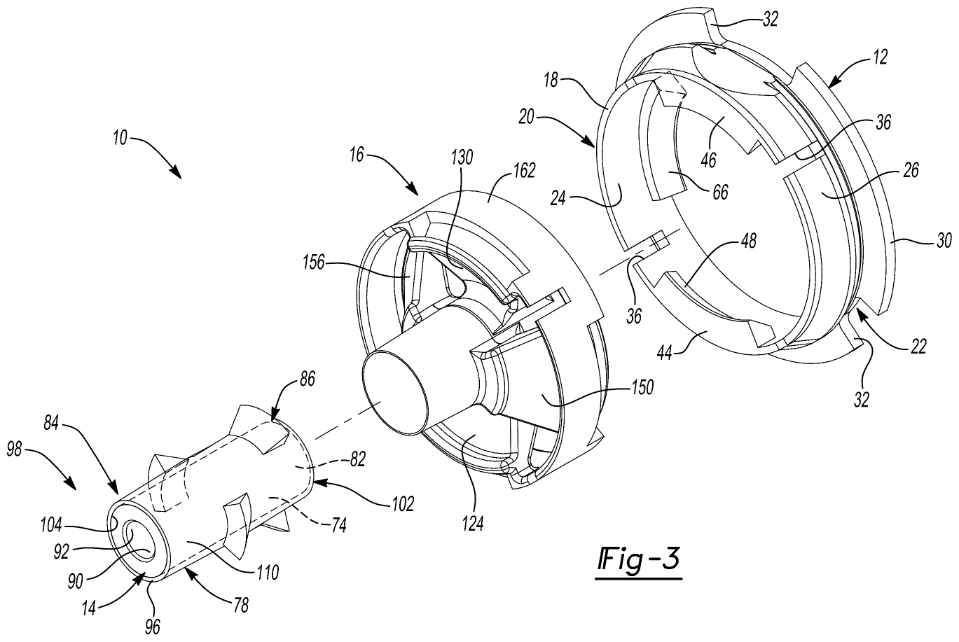

With reference to FIGS. 1-7, an exemplary isolator is depicted at reference numeral 10. Isolator 10 includes an outer shell 12, an inner core 14, and an elastomer 16 positioned therebetween. Outer shell 12 includes a cylindrical body 18 having a first end 20 and an opposite second end 22. Body 18 includes an inner cylindrical surface 24 and an outer cylindrical surface 26. Outer shell 12 also includes a flange 30 radially outwardly extending from body 18 at second end 22.

In the particular embodiment depicted in FIGS. 1-7, flange 30 includes a plurality of circumferentially spaced apart recesses 32. Recesses 32 are sized and shaped to cooperate with portions of the vehicle (not shown) to which isolator 10 is attached. It should be appreciated that recesses 32 need not be present. A plurality of circumferentially spaced apart and longitudinally extending slots 36 radially extend through body 18. Slots 36 are also optional and are useful in the embodiment depicted to provide a snap-fit interconnection between body 18 and the vehicle.

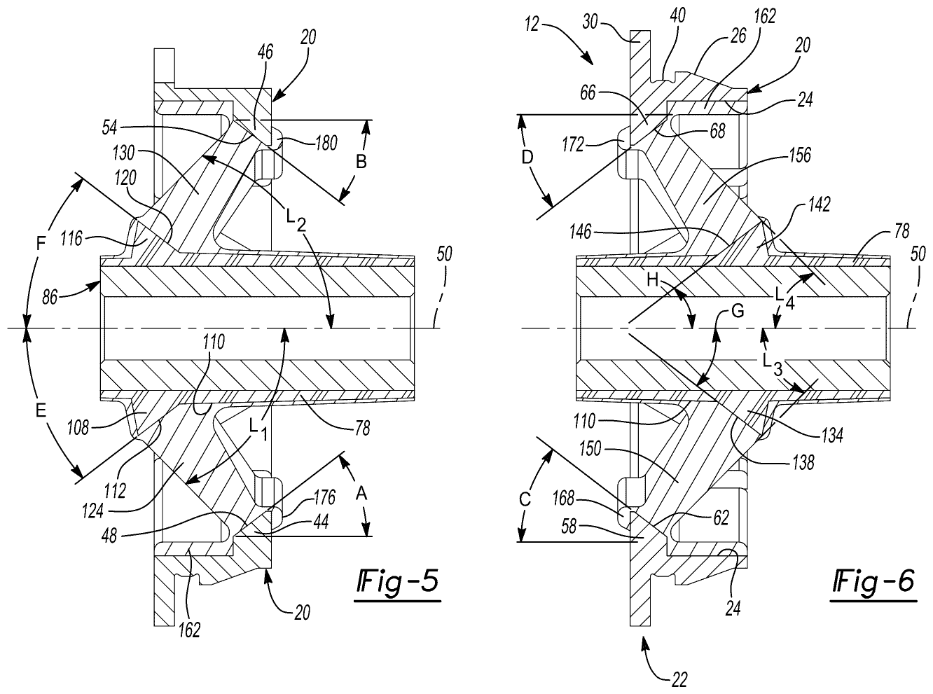

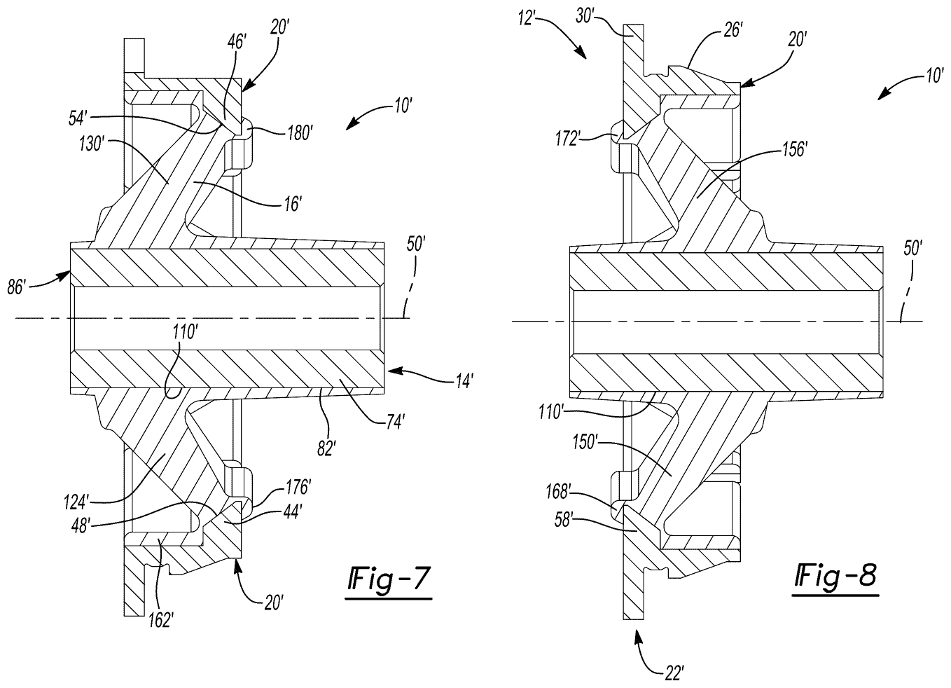

As best shown in FIGS. 5 and 6, outer cylindrical surface 26 may include an optional frustoconical cross-sectional shape to facilitate insertion of body 18 into an aperture of vehicle (not shown). During insertion, segments of body 18, as defined by slots 36, may radially inwardly deflect temporarily during the coupling process. A groove 40 is provided adjacent to flange 30 to further define the snap-fit coupling arrangement between outer shell 12 and the vehicle. These features are also optional. In an alternate arrangement, it is contemplated that the frustoconically shaped outer surface 26 may be shaped as a right circular cylinder and groove 40 need not be present. As such, outer shell 12 may simply be press-fit into a cylindrical bore to retain isolator 10 to the vehicle.

Outer shell 12 includes a first lug 44 radially inwardly extending from inner cylindrical surface 24. First lug 44 is positioned at first end 20. A second lug 46 is diametrically opposed from first lug 44. Second lug 46 radially inwardly extends from inner cylindrical surface 24. Second lug 46 is also positioned at first end 20. First lug 44 circumferentially extends less than 90°. Similarly, second lug 46 circumferentially extends less than 90° and, in at least in one embodiment, extends the same circumferential amount as first lug 44. First lug 44 includes a curved first mounting surface 48 that may be conically shaped as depicted in the figures. As shown in FIG. 5, first mounting surface 48 extends at an angle A with relation to a longitudinal axis 50 of isolator 10. Second lug 46 includes a second mounting surface 54 that extends at an angle B relative to axis 50. Angle B may, but need not, equal angle A. Angle A and angle B may range from 30 to 60 degrees.

As best shown in FIG. 6, outer shell 12 also includes a third lug 58 radially inwardly extending from inner cylindrical surface 24. Third lug 58 is positioned at second end 22 of body 18. Third lug 58 includes a third mounting surface 62 that extends at an angle C when viewed in cross section as depicted in FIG. 6. A fourth lug 66 radially inwardly extends from inner cylindrical surface 24 and is positioned at second end 22. Third lug 58 and fourth lug 66 each circumferentially extend less than 90°. Fourth lug 66 is diametrically opposed from third lug 58. As such, third lug 58 and fourth lug 66 may be considered as being positioned along the same line as one another that also passes through axis 50. The pair of first lug 44 and second lug 46 may also be viewed as extending along the same radial line that intersects axis 50. This pair of first and second lugs, however, are rotated 90° relative to the third lug and fourth lug pair. Fourth lug 66 includes a fourth mounting surface 68. Fourth mounting surface 68 extends at an angle D as depicted in FIG. 6. It is contemplated that angle C and angle D may be equal in the embodiment of FIG. 6. It should be appreciated, however, that angle C and D need not be equal. Angle C and angle D may range from 30 to 60 degrees.

Inner core 14 includes an inner sleeve 74 and an inner shell 78 over molded and fixed to an outer surface 82 of inner sleeve 74. Inner sleeve 74 is a circular cylindrical member extending from a first end 84 to a second end 86. Inner sleeve 74 includes a bore 90 defined by an inner surface 92. Inner sleeve 74 may be constructed from a metal such as aluminum or a mild steel alloy. Inner shell 78 may be constructed from a plastic material such as reinforced nylon 6-6. Inner shell 78 includes a tubular cylindrical wall 96 having a first end 98 and an opposite second end 102. Inner shell 78 includes an inner surface 104 over molded on and directly engaging outer surface 82 of inner sleeve 74.

As best shown in FIG. 5, inner shell 78 includes a first barb 108 radially outwardly extending from an outer surface 110 of inner shell 78. First barb 108 includes a first seat 112. First seat 112 includes a frustoconical shape. First seat 112 extends at an angle E relative to longitudinal axis 50 having a magnitude such that first seat 112 and first mounting surface 48 extend substantially parallel to one another. As such, angle A and angle E may be the same or substantially similar in magnitude to one another.

A second barb 116 radially outwardly extends from outer surface 110 of inner shell 78. Second barb 116 is diametrically opposed to first barb 108. Second barb 116 includes a second seat 120 that extends at an angle F relative to longitudinal axis 50. Angle E and angle F are shown as being equivalent to one another in the figures. It should be appreciated that these angles need not necessarily be the same. Angle E and angle F may range from 30 to 60 degrees. Second seat 120 extends substantially parallel to second mounting surface 54 on second lug 46.

Elastomer 16 includes a first web or leg 124 bonded to first seat 112 and first mounting surface 48. First leg 124 has a first circumferential extent at first barb 108 and a second substantially greater second circumferential extent at second lug 46. A second web or leg 130 radially outwardly extends from second seat 120 of second barb 116 to second mounting surface 54 of second lug 46. Second leg 130 is substantially similarly shaped, if not exactly shaped the same, as first leg 124. First leg 124 extends at an angle L₁ relative to axis 50. Second leg 130 extends and an angle L₂ relative to axis 50. In the embodiment depicted in FIG. 5, L₁ equals angle L₂. It is envisioned that angles L₁ and L₂ are substantially 45°±10°.

With reference to FIG. 6, inner shell 78 includes a third barb 134 radially outwardly protruding from outer surface 110 of inner shell 78. Third barb 134 is axially positioned near or at the middle of the longitudinal extent of inner shell 78. Third barb 134 includes a third seat 138. Third seat 138 extends at an angle G relative to axis 50. It is envisioned that third seat 138 extends substantially parallel to third mounting surface 62 of third lug 58. A fourth barb 142 radially outwardly extends from outer surface 110 of inner sleeve 78. Fourth barb 142 is diametrically opposed from third barb 134. Fourth barb 142 includes a fourth seat 146 extending substantially parallel to fourth mounting surface 68 of fourth lug 66. Fourth seat 146 extends an angle H in relation to axis 50. In the embodiment depicted in FIG. 6, angles G and H are the same but they need not necessarily be equal to one another in alternate embodiments. Third seat 138 and fourth seat 146 are frustoconically shaped surfaces having an arc length of approximately 60 degrees. It is envisioned that the arc length may range from 45 to 75 degrees.

Elastomer 16 includes a third web or leg 150 bonded to and extending between third seat 138 and third mounting surface 62. Third leg 150 has a variable cross-sectional thickness with the minimum thickness being positioned adjacent third lug 58 and the maximum thickness being positioned at third barb 134. Third leg 150 circumferentially extends in substantially the same manner as first leg 124 in that a first circumferential extent the third leg 150 exists a third barb 134 and substantially greater circumferential extent is provided at third leg 58. Third leg 150 extends at an angle L₃ relative to axis 50.

A fourth web or leg 156 is substantially the mirror image of third leg 150. Fourth leg 156 is bonded to and extends between fourth mounting surface 68 and fourth seat 146. It should be appreciated that all portions of elastomer 16 are integrally formed with one another as a one-piece elastomer. Such a structural arrangement may be achieved by over molding elastomer 16 to inner shell 78 and outer shell 12. Fourth leg 156 extends at an angle L₄ in relation to axis 50. In the embodiment depicted in FIG. 6, L₃=L₄. As previously noted, these angles need not be equal in alternate embodiments.

When comparing FIG. 5 with FIG. 6, it should be apparent that a first pair of legs 124, 130 extends from inner core 14 beginning at an axial position proximate second end 86 of inner sleeve 74. The first pair of legs defines a conical cross-section that opens toward first end 20 of outer shell 12. FIG. 6 depicts a second pair of legs, namely third leg 150 and fourth leg 156, that extend in the opposite longitudinal direction as the first pair of legs. In particular, third leg 150 and fourth leg 156 originate on inner core 14 at a longitudinal position substantially aligned with first end 20 of outer shell 12 and define a conical cross-section. The second pair of legs open as they extend toward second end 22 of outer shell 12. By arranging opposing pairs of legs 124, 130, 150, 156 as previously described, a radial rate of deflection per unit load may be defined to be substantially similar to an axial rate of deflection per unit load when inducing relative movement between inner core 14 and outer shell 12. The geometry of the legs may be adjusted to vary the radial and axial rates.

To enhance the interconnection between inner core 14 and outer shell 12, elastomer 16 includes an integrally formed hub portion 162 bonded to inner cylindrical surface 24 of outer shell 12. Third leg 150 and fourth leg 156 may include bumper portions 168, 172, respectively. First leg 124 and second leg 130 may also include bumper portions 176, 180, respectively.

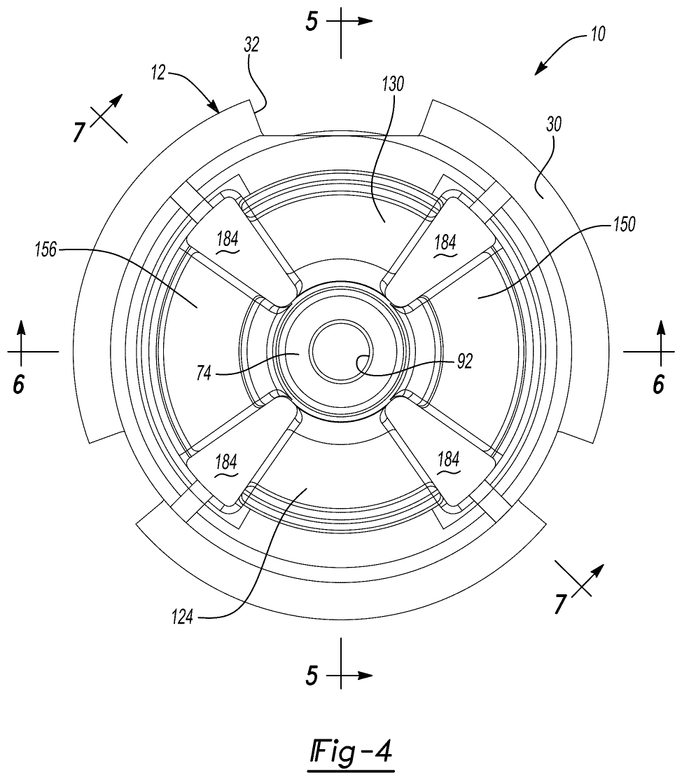

As best shown in FIG. 4, each of first leg 124, second leg 130, third leg 150, and fourth leg 156 are circumferentially spaced apart from one another to define a plurality of gaps 184 longitudinally extending through elastomer 16. When isolator 10 is mounted in the vertical orientation such that axis 50 is perpendicular to the ground, gaps 184 function as passageways allowing drainage of water or contaminants, if necessary.

With reference to FIG. 7 an alternate embodiment isolator is identified at reference numeral 10′. Isolator 10′ is substantially similar to isolator 10. As such, like elements will retail their previously introduced reference numerals including a prime suffix. To avoid repetition, only the substantive differences in the embodiments will be described in detail. For instance, inner core 14′ only singular component that being inner sleeve 74′. Isolator 10′ does not include an overmolded plastic inner shell 78 as described with reference to isolator 10.

Elastomer 16′ including each of first leg 124′, second leg 130′, third leg 150′ and fourth leg 156′ are each directly bonded to outer surface 82′ of inner sleeve 74′.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. An isolator comprising:
an inner core including a bore extending therethrough;
an outer shell including a cylindrical wall; and
an elastomer positioned radially between the inner core and the outer shell, the elastomer including a first leg and a diametrically opposed second leg as well as a third leg and a diametrically opposed fourth leg;
wherein the first leg and the second leg each interconnect the inner core and the outer shell and originate at the inner core and diverge radially outwardly along a first longitudinal direction,
wherein the third leg and the fourth leg each interconnect the inner core and the outer shell and originate at the inner core and diverge radially outwardly along a second longitudinal direction opposite to the first longitudinal direction.

2. The isolator according to claim 1, wherein each of the first, second, third, and fourth legs are circumferentially spaced apart from one another.

3. The isolator according to claim 1, wherein each of the first, second, third, and fourth legs overlap one another when viewed in cross-section passing through a longitudinal axis of the bore.

4. The isolator according to claim 1, wherein the outer shell includes first, second, third, and fourth lugs fixed to each of the each of the first, second, third, and fourth legs, respectively.

5. The isolator according to claim 4, wherein the inner core includes first, second, third, and fourth radially outwardly extending barbs fixed to each of the each of the first, second, third, and fourth legs, respectively.

6. The isolator according to claim 5, wherein each of the first, second, third, and fourth barbs includes a seat bonded to each of the each of the first, second, third, and fourth legs, respectively, the seats extending at angles ranging from 30 to 60 degrees relative to the longitudinal axis.

7. The isolator according to claim 6, wherein each of the first, second, third, and fourth lugs includes a mounting surface bonded to each of the first, second, third, and fourth legs, respectively, the first mounting surface extending substantially parallel to the first seat.

8. The isolator according to claim 4, wherein the first and second lugs radially inwardly extend from the cylindrical wall at a first longitudinal position.

9. The isolator according to claim 4, wherein the third and fourth lugs radially inwardly extend from the cylindrical wall at a second longitudinal position different than the first longitudinal position.

10. The isolator according to claim 1, wherein the inner core includes an inner sleeve and an inner shell over-molded and fixed to an outer surface of the inner sleeve, wherein the first, second, third, and fourth legs are bonded to the inner sleeve.

11. The isolator according to claim 1, wherein the outer shell includes an outer surface including a groove adapted to receive a portion of a component to which the isolator is attached.

12. The isolator according to claim 1, wherein the inner core includes a longitudinal length greater than a longitudinal length of the outer shell, the inner core extending entirely through the outer shell and having opposite ends positioned on opposite sides of the cylindrical wall.

13. The isolator according to claim 1, wherein the inner core includes a longitudinal axis coaxially aligned with a longitudinal axis of the outer shell.

14. The isolator according to claim 1, wherein a gap is provided between each adjacent pair of the first, second, third, and fourth legs, the gaps longitudinally extending through the elastomer.

15. An isolator comprising:
an inner core including a bore extending longitudinally therethrough;
an outer shell including a cylindrical wall circumscribing the inner core; and
an elastomer positioned radially between and interconnecting the inner core and the outer shell, the elastomer including a first leg and a diametrically opposed second leg as well as a third leg and a diametrically opposed fourth leg;
wherein the first leg and the second leg define a first pair of legs arranged to define a conical cross-section that opens in a first longitudinal direction,
wherein the third leg and the fourth leg define a second pair of legs arranged to define a conical cross-section that opens in a second longitudinal direction opposite to the first longitudinal direction.

16. The isolator according to claim 15, wherein each of the first, second, third, and fourth legs are circumferentially spaced apart from one another.

17. The isolator according to claim 15, wherein the outer shell includes first, second, third, and fourth lugs fixed to each of the each of the first, second, third, and fourth legs, respectively.

18. The isolator according to claim 15, wherein the inner core includes first, second, third, and fourth radially outwardly extending barbs fixed to each of the each of the first, second, third, and fourth legs, respectively.

19. The isolator according to claim 18, wherein each of the first, second, third, and fourth barbs includes a seat bonded to each of the each of the first, second, third, and fourth legs, respectively, the seats extending at angles ranging from 30 to 60 degrees relative to the longitudinal axis.

20. The isolator according to claim 17, wherein the first and second lugs radially inwardly extend from the cylindrical wall at a first longitudinal position and the third and fourth lugs radially inwardly extend from the cylindrical wall at a second longitudinal position different than the first longitudinal position.
